(19) United States
(12) Patent Application Publication
(10) Pub. No.: US 2011/0055589 A1
(43) Pub. Date: Mar. 3, 2011

(54) INFORMATION CERTIFICATION SYSTEM

(76) Inventors: Tieh-Chin HSIEH, Guanyin Township (TW); Chih-Fang Lai, Sanchong City (TW)

(21) Appl. No.: 12/552,059

(22) Filed: Sep. 1, 2009

(51) Int. Cl. G06F 21/24; G06F 12/14

(52) U.S. Cl. 713/189; 726/30

(57) ABSTRACT

The invention discloses an information certification system including a data processing device and a portable storage medium. The portable storage medium includes a transmission interface and a memory array. The portable storage medium is removably coupled to the data processing device through the transmission interface. The memory array includes a hidden storage area. When a protected program is executed on the data processing device, the data processing device sends a certification request to the portable storage medium. The portable storage medium checks the certification request and selectively returns certification information stored in the hidden storage area back to the data processing device. Wherein, the certification information corresponds to the protected program.

### BACKGROUND OF THE INVENTION

1. Field of the Invention

The invention relates to an information certification system and, more particularly, to an information certification system utilizing a hidden storage area in a portable storage medium as a certification storage medium.

2. Description of the Prior Art

With the ever-developing technology, the consumer-electronics become more personalized and humanized. The interchange of software information over modern networks is much easier and popular. Therefore, a lot of applications on the internet are emerged, such as some information certification applications in user identification or software authorization.

For example, in the application of the software authorization, it takes some verification efforts on user's identification, for confirming whether the user grants the legal license to operate the software or not. There are some traditional certification methods including: entering a specific registration code, inserting the original disc, or even installing some specific hardware component (e.g. inserting a Dongle or Keypro to the printer port or USB port). Among those solutions, the license key connector (i.e. Dongle or Keypro) is basically an effective and direct way for certification. For example, when a protected program is executed, it sends an electronic certification signal to a couple of pins on the printer port and measures the response. If there is license key connector installed on the printer port, a voltage or current feedback signal will be generated by the license key connector, so as to represent that the certification is successful. This kind of license key connector, which is realized by simply circuit structure and can not be cracked in a software hacking way, is widely adopted by high-end software companies.

However, aforesaid circuit-level decryption hardware has its limitation because of hardware structure of the license key connector. The maximum amount of certification combinations has an upper boundary limited by the total amount of the pins on the license key connector, so as to limit its usage.

Portable storage media, such as USB flash discs or memory cards, are widely spread now. For the USB flash disc, a hidden storage area can be divided from the storage space of the flash disc by specific space-partitioning software. The hidden storage area can be used for storing some personal or business confidential data. The hidden storage area can only be accessed through specific controlling software invented by the flash disc producer. Most USB drivers now have relative instruction sets for this function. However, for the memory card, such as secure digital (SD) card or compact flash (CF) card, the memory card drivers on most operating systems (OS) can not communicate with the controller of the memory card for this purpose. Therefore, most available memory cards do not implement the function of the hidden storage area.

By utilizing the portable storage medium (e.g. flash disc or memory card) as a certification storage medium, some serial number or algorithm needed by a protected program can be stored in the hidden storage area inaccessible to common operating systems. This certification structure can be applied in various applications. The invention discloses an information certification system utilizing a hidden storage area in a portable storage medium as a certification storage medium, so as to solve aforesaid problems.

### SUMMARY OF THE INVENTION

A scope of the invention is to provide information certification system, which includes a data processing device (e.g. PC) and a portable storage medium (e.g. memory card).

According to an embodiment, the portable storage medium includes a transmission interface and a memory array. The portable storage medium is removably coupled to the data processing device through the transmission interface. The memory array includes a hidden storage area. When a protected program is executed on the data processing device, the data processing device sends a certification request to the portable storage medium. The portable storage medium checks the certification request and selectively returns certification information stored in the hidden storage area back to the data processing device. Wherein, the certification information corresponds to the protected program.

Compared with the circuit-level license key connector (e.g. Dongle or Keypro) or the certification system based on USB flash disc, the invention may utilize any kinds of memory cards as the certification storage medium, and it may store serial number or algorithm needed by a protected program in the hidden storage area inaccessible to common operating systems. When the protected program is started or while the protected program is active, the data processing device may read the serial number or the algorithm for further extracting, decrypting, executing or activating the protected program, so as to realize the identification authentication function.

The advantage and spirit of the invention may be understood by the following recitations together with the appended drawings.

### BRIEF DESCRIPTION OF THE APPENDED DRAWINGS

FIG. 1 is a schematic diagram illustrating an information certification system according to a first embodiment of the invention.

FIG. 2 is a function block diagram illustrating the information certification system in FIG. 1.

FIG. 3 is a function block diagram illustrating an information certification system 3 according to a second embodiment of the invention.

### DETAILED DESCRIPTION OF THE INVENTION

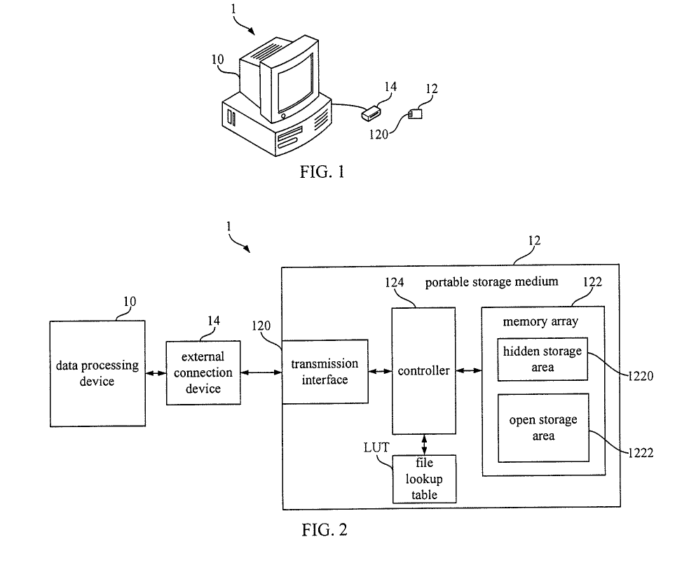

Please refer to FIG. 1 and FIG. 2. FIG. 1 is a schematic diagram illustrating an information certification system 1 according to a first embodiment of the invention. FIG. 2 is a function block diagram illustrating the information certification system 1 in FIG. 1. As shown in FIG. 1, the information certification system 1 includes data processing device 10, portable storage medium 12 and an external connection device 14.

In this embodiment, the information certification system 1 takes a personal computer for example, but the invention is not limited to this. In practical applications, the information certification system 1 can be a personal computer, a server, a smart phone or a personal digital assistant (PDA). The portable storage medium 12 can be a memory card adopting a general specification. The portable storage medium 12 includes a transmission interface 120. In this embodiment the transmission interface 120 may adopt an interface specification selected from the group consisting of compact flash (CF) card interface, multimedia memory card (MMC) interface, secure digital (SD) card interface, smart media (SM) card interface, extreme digital (XD) card interface and memory stick (MS) card interface.

As shown in FIG. 1, the external connection device 14 is coupled to the data processing device 10. The data processing device 10 connects with the transmission interface 120 of the portable storage medium 12 through the external connection device 14.

In practical applications, the user may insert the portable storage medium 12 into the external connection device 14, or on the contrary remove the portable storage medium 12 from the external connection device 14, but the invention is not limited to this. In another embodiment, the data processing device 10 may include a built-in connector (not shown). The user may insert the portable storage medium 12 into the built-in connector, or on the contrary remove the portable storage medium 12 from the built-in connector of the data processing device 10. That is to say, the portable storage medium 12 is removably coupled to the data processing device 10 through the transmission interface 120.

In the embodiment, the portable storage medium 12 also includes a memory array 122 and a controller 124. The controller 124 is electrically connected to the transmission interface 120 and the memory array 122. The controller 124 is used for controlling the access operation to the memory array 122. The controller 124 in this embodiment may not only be used to perform the standard access operations to the memory array 122, but also perform some custom read/write/access operations other than the standard access operations according to different request messages defined by the producer of the information certification system 1.

In the embodiment, the memory array 122 of the portable storage medium 12 includes a hidden storage area 1220 and an open storage area 1222. The open storage area 1222 is a storage area, which adopts a general specification (e.g. FAT32 format or NTFS format) and is able to be read or written by a general-purpose OS. To be noticed that, the portable storage medium 12 has the hidden storage area 1220, which is an exceptional defined area and not known by the general-purpose OS. Because the hidden storage area 1220 is not directly compatible to the general-purpose OS, the data in the hidden storage area 1220 are not going to be violated even in the case that the general-purpose OS is invaded by a computer virus or that the portable storage medium 12 is re-formatted by the general-purpose OS.

In the embodiment, the only way to access the hidden storage area 1220 is to send a custom controlling signal to the controller 124 on the portable storage medium 12, for informing the controller 124 to do the corresponding access action to the hidden storage area 1220. The custom controlling signal can be generated by specific control software designed by the producer of the information certification system 1. There are several ways to realize the hidden storage area 1220. For example, the portable storage medium 12 may further store a file lookup table LUT. The file lookup table LUT can be used for recording the sector or cylinder information of the hidden storage area 1220, such that the controller 124 may access the hidden storage area 1220 according to the file lookup table LUT.

When the data processing device 10 intend to execute one specific protected program (e.g. when the user want to install or activate virus-proof software with copyright, or when the virus-proof software with copyright has been operating for a predetermined cycle period), the data processing device 10 may call the custom control software designed by the producer. The control software can be stored in the data processing device 10 or the portable storage medium 12. The data processing device 10 may generate a certification request with the control software and sends the certification request to the controller 124 of the portable storage medium 12. The controller 124 checks the certification request, and accordingly the controller 124 may selectively load and return certification information stored in the hidden storage area 1220 to the data processing device 10.

The certification information can be a serial number or an algorithm corresponding to the protected program. After the data processing device 10 fetches the certification information (i.e. the serial number or the algorithm), the serial number can be used for activating the protected program, or in the other case the algorithm can be used for decompressing, decrypting, executing or activating the protected program. In other words, the data processing device 10 may load the certification information in the hidden storage area 1220 and finishes the certification action.

Aforesaid protected program can be pre-installed in the data processing device 10. In another case, the protected program can be stored in the open storage area 1222 of the portable storage medium 12, and can be executed on different computers, servers, smart phones or PDA to the mobility need of the user.

The following is usage example of the information certification system 1 of the invention. The software companies may record their products in the open storage area 1222 of the portable storage medium 12, and then sell it to their client. When the protect programs are started or during the protect programs are executing, the protect programs need to load and check the certification information from the hidden storage area 1220 of the portable storage medium 12. In this way, it is easier for the software companies to monitor the total amount of machines, which have legal right to use the protected programs, such that it can prevent the protected programs from being pirated or copied.

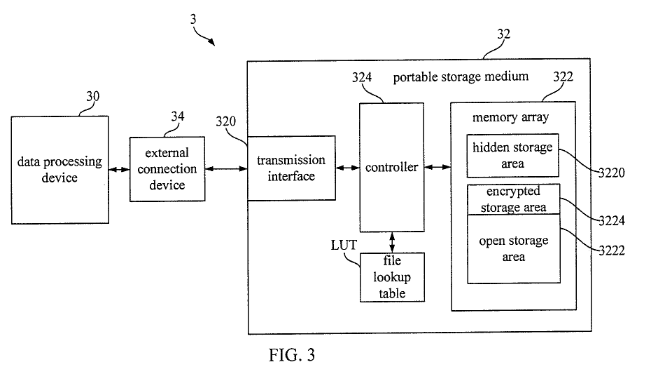

Please refer to FIG. 3. FIG. 3 is a function block diagram illustrating an information certification system 3 according to a second embodiment of the invention. The main different from the first embodiment is that, in the information certification system 3 in the second embodiment, the memory array 322 of the portable storage medium 32 further includes an encrypted storage area 3224 for storing encrypted data. The encrypted storage area 3224 is an encrypted space defined by a general-purpose operating system, which means that the operating system of the data processing device 30 acknowledges the existence of the encrypted storage area 3224. When the user wants to access the encrypted storage area 3224, the operating system may ask the user to enter corresponding password, decryption algorithm or decryption executable file. The file encryption system is known by people in the art, and not to be further introduced here.

In the information certification system 3 of the embodiment, the password or the decryption algorithm corresponding to the encrypted storage area 3224 is stored in the hidden storage area 3220. When the user to access the encrypted data in the encrypted storage area 3224, the user may execute specific control software on the data processing device (the control software in this embodiment can be the same one used for communicating with the portable storage medium in the first embodiment), for generating a decrypted request to the controller 324 of the portable storage medium 32. The controller 324 checks the decrypted request. According to the decrypted request, the controller 324 selectively reads the hidden storage area 3220 and returns the password or the decrypting algorithm. Then the data processing device 30 decrypts and accesses the encrypted data in the encrypted storage area 3224 according to the password or the decrypting algorithm.

In another embodiment, the portable storage medium 32 may have an auto-run procedure. When the user couples the portable storage medium 32 to the data processing device 30, the auto-run procedure may automatically generate the decryption request, for fetching the encryption data via the aforesaid steps in the second embodiment.

That is to say, the hidden storage area 3220 of the information certification system 3 in the second embodiment may serve as a license key library corresponding to other encrypted space. The other components and the detail actions of the hidden storage area 3220 are similar to the previous descriptions in the first embodiment, and are not repeated here.

In summary, compared with the circuit-level license key connector (e.g. Dongle or Keypro) or the certification system based on USB flash disc, the invention may utilize any kinds of memory cards as the certification storage medium, and it may store serial number or algorithm needed by a protected program in the hidden storage area inaccessible to common operating systems. When the protected program is started or while the protected program is active, the data processing device may read the serial number or the algorithm for further extracting, decrypting, executing or activating the protected program, so as to realize the identification authentication function.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An information certification system, comprising:
a data processing device; and
a portable storage medium comprising;
a transmission interface, the portable storage medium being removably coupled to the data processing device through the transmission interface; and
a memory array comprising a hidden storage area;
wherein when a protected program is executed on the data processing device, the data processing device sends a certification request to the portable storage medium, the portable storage medium checks the certification request and selectively returns certification information stored in the hidden storage area back to the data processing device, and the certification information corresponds to the protected program.

2. The information certification system of claim 1, wherein the protected program is stored in the data processing device.

3. The information certification system of claim 1, wherein the memory array comprises an open storage area, the protected program is stored in the open storage area.

4. The information certification system of claim 1, wherein the certification information comprises a certification serial number corresponding to the protected program, the certification serial number is used for activating the protected program.

5. The information certification system of claim 1, wherein the certification information comprises an algorithm corresponding to the protected program, the algorithm is used for decompressing, decrypting, executing or activating the protected program.

6. The information certification system of claim 1, wherein the portable storage medium further comprises:
a controller electrically connected to the memory array and the transmission interface, the controller is used for accessing the memory array;
wherein control software is stored in the data processing device or the portable storage medium, when the protected program is started on the data processing device, the data processing device generates the certification request with the control software and sends the certification request to the controller of the portable storage medium, the controller checks the certification request, and accordingly the controller selectively loads and returns the certification information stored in the hidden storage area.

7. The information certification system of claim 6, wherein the portable storage medium further comprises a file lookup table, and the controller accesses the hidden storage area according to the file lookup table.

8. The information certification system of claim 6, wherein the memory array further comprises:
an encrypted storage area, storing an encrypted data;
wherein there is a password or a decrypting algorithm corresponding to the encrypted storage area stored in the hidden storage area, when the data processing device wants to access the encrypted data, the data processing device generates a decrypted request with the control software and sends the decrypted request to the controller of the portable storage medium, the controller checks the decrypted request, accordingly the controller selectively reads the hidden storage area and returns the password or the decrypting algorithm, and the data processing device decrypts and accesses the encrypted data in the encrypted storage area according to the password or the decrypting algorithm.

9. The information certification system of claim 6, wherein the memory array further comprises:
an encrypted storage area, storing an encrypted data;
wherein there is a password or a decrypting algorithm corresponding to the encrypted storage area stored in the hidden storage area, there is an auto-run procedure stored in the portable storage medium, when the portable storage medium is coupled to the data processing device, the auto-run procedure generates a decrypted request and sends the decrypted request to the controller of the portable storage medium, the controller checks the decrypted request, accordingly the controller selectively reads the hidden storage area and returns the password or the decrypting algorithm, and the data processing device decrypts and accesses the encrypted data in the encrypted storage area according to the password or the decrypting algorithm.

10. The information certification system of claim 1, wherein the data processing device further checks the certification information returned by the portable storage medium, and if the certification information is invalid or expired, the data processing device generates a certification failure message.

11. The information certification system of claim 1, wherein the data processing device further checks whether the data processing device is coupled with the portable storage medium or not, and if the data processing device is not coupled with the portable storage medium, the data processing device generates a certification failure message.

12. The information certification system of claim 1, wherein the data processing device is a personal computer, a server, a smart phone or a personal digital assistant.

13. The information certification system of claim 1, wherein the data processing device further comprises a built-in connector, the data processing device connects with the transmission interface of the portable storage medium through the built-in connector.

14. The information certification system of claim 1, further comprising an external connection device, the external connection device being coupled to the data processing device, and the data processing device connecting with the transmission interface of the portable storage medium through the external connection device.

15. The information certification system of claim 1, wherein the transmission interface of the portable storage medium adopts an interface specification selected from the group consisting of compact flash card interface, multimedia memory card interface, secure digital card interface, smart media card interface, extreme digital card interface and memory stick card interface.

16. The information certification system of claim 1, wherein the memory array is a non-volatile memory.
